(19) United States
(12) Patent Application Publication
(10) Pub. No.: US 2025/0052991 A1
(43) Pub. Date: Feb. 13, 2025

(54) Microscope and Method for Microscopy

(71) Applicant: Carl Zeiss Microscopy GmbH, Jena (DE)

(72) Inventors: Tiemo Anhut, Jena (DE); Daniel Schwedt, Jena (DE); Matthias Wald, Jena (DE)

(21) Appl. No.: 18/723,002

(22) PCT Filed: Nov. 21, 2022
(86) PCT No.: PCT/EP2022/082544

§ 371 Date: Jun. 21, 2024

(30) Foreign Application Priority Data
Dec. 22, 2021 (DE) 10 2021 134 427.1

(51) Int. Cl. G02B 21/18; G02B 21/00; G02B 21/36

(52) U.S. Cl. CPC G02B 21/18; G02B 21/0076; G02B 21/008; G02B 21/361; G02B 21/367

(57) ABSTRACT

A microscope comprising an illumination beam path comprising an illumination control device and an illumination objective for illuminating and scanning a sample with excitation light, a detection beam path comprising a microscope objective for guiding emission light emitted by the sample in the direction of a camera for recording images of the sample, and a control unit for controlling the illumination control device and the camera. The control unit being configured to synchronize regions to be read of a sensor area of the camera with a position of the excitation light defined by the illumination control device, wherein the detection beam path includes an image splitter unit for splitting the emission light into multiple partial beam paths which each generate a partial image of the sample, the partial images lying next to one another such that linear regions in the partial images lie on the same line(s) of the sensor area.

In a first aspect, the present invention relates to a microscope according to the preamble of claim 1. Moreover, the invention relates to a method for microscopy.

A microscope of the generic type is known for example from U.S. Pat. No. 7,335,898 and comprises: an illumination beam path at least comprising an illumination control device and an illumination objective for, in particular linearly, illuminating and scanning a sample with excitation light, a detection beam path at least comprising a microscope objective for guiding emission light emitted by the sample in the direction of a camera, the camera for recording images of the sample, and a control unit for controlling at least the illumination control device and the camera. The control unit is configured to synchronize in each case regions to be read of a sensor area of the camera with a position of the excitation light defined by the illumination control device.

Processes in cell conglomerates, organs or whole animals are increasingly being studied in biomedical research. The examination objects are therefore generally no longer flat two-dimensional objects on glass substrates, but rather three-dimensional objects which are intended to be observed as a whole volume with high sensitivity at high speed. For three-dimensional microscopic imaging, the laser scanning microscope (LSM) has become established, but cannot satisfy the demand for high volume rates.

Higher frame rates can be achieved by parallelization. Solutions in respect thereof have been presented in U.S. Pat. No. 7,335,898, for example. In that case, the sample is scanned with a linear light distribution which is synchronized with the rolling shutter of a CMOS camera. The rolling shutter acts there like a movable electronic confocal stop and thus makes possible the optical sectioning known from the LSM with correspondingly high-contrast imaging. With this technology, higher frame rates are indeed already possible, but the volume rates remain limited to a few volumes per second. Moreover, line illumination in a larger axial sample region causes an increased sample burden since the light intensity falls off only linearly with distance from the focal plane, rather than quadratically as in the case of point illumination. The radiation intensity thus remains high over an extended axial region, without information about the sample being captured. This unavoidable effect in the case of line illumination is disadvantageous in particular in regard to nonlinear bleaching as exhibited by fluorescent proteins that are relevant especially (Sci. Rep. 2015 Oct. 20;5:15348. doi: 10.1038/srep15348.

In order to reduce the sample burden and at the same time to increase the volume rate, microscope systems parallelized in an axial direction additionally have been proposed (Jean-Marc Tsang et al., Biomed. Opt. Expr. 12, 1339 (2021)). In that case, a reflective slit is arranged in three different axial planes in order to reflect the emission from the plane conjugate thereto in the direction of a camera. The proposed arrangement is complex to the effect that the emission has to be rescanned onto the camera. Consequently, many successive imaging stages are necessary, which lead to losses and imaging aberrations. Moreover, this arrangement is not very flexible since the reflecting elements that perform the function of the confocal line stop have been integrated into the beam path in a positionally fixed and invariable manner. However, as in the point scanning system, too, this stop must be adaptable to the objective.

Sizes of e.g. one Airy unit (AU) are generally used as stop sizes. An Airy unit is defined here by way of imaging the point spread function in the sample, which is determined by the numerical aperture (NA) of the objective, with the corresponding magnification factor, as given by the objective and the tube lens, into the plane of the stop. An adaptation becomes necessary if adjustment of different resolution levels and image field sizes is desirable. In the case of the solution proposed by Tsang et al., the stops are imaged onto the camera. If there are surface defects, disturbing streaks may thus occur in the image.

From widefield microscopy, then, approaches for so-called image splitting are known which make it possible to arrange a plurality of object planes next to one another on a camera sensor (GB2442576B or Sheng Xiao et al., Optica 7, 1477 (2020)). In particular the arrangement from Sheng Xiao et al. may tend toward image artefacts since optical interfaces are arranged in the vicinity of the image planes. Other arrangements, for instance the setup described in WO13106731A1, are comparatively complex and do not appear to be suitable for series production.

An object of the invention can be considered that of specifying a microscope and a method for microscopy in which high frame and volume rates are achieved in conjunction with an acceptable light burden on the samples and acceptable apparatus complexity.

This object is achieved by means of the microscope having the features of claim 1 and by means of the method having the features of claim 24.

The microscope of the type specified above is developed according to the invention by virtue of the fact that the detection beam path includes an image splitter unit for splitting the emission light into a plurality of partial beam paths which each generate a partial image of the sample on the sensor area of the camera, the partial images lying next to one another on the sensor area in such a way that linear regions in the partial images which correspond to a position of the excitation light on or in the sample as defined by the illumination control device lie on the same line or the same lines of the sensor area.

In the method for microscopy according to the invention, the following steps are carried out: a sample is, in particular linearly, illuminated and scanned with excitation light by an illumination objective, emission light emitted by the sample is guided in the direction of a camera via a microscope objective, downstream of the microscope objective the emission light is split into a plurality of partial beam paths, wherein each of the partial beam paths generates a partial image of the sample on a sensor area of the camera, and wherein the partial images of the sample lie next to one another on the sensor area in such a way that linear regions in the partial images which correspond to a position of the excitation light on or in the sample lie on the same line or the same lines of the sensor area, and, finally, regions to be read of the sensor area of the camera are synchronized with the position of the excitation light on the sample.

The microscope according to the invention is suitable for carrying out the method according to the invention. The method according to the invention can be carried out in particular by the microscope according to the invention.

Preferred configurations of the microscope according to the invention and advantageous variants of the method according to the invention are explained below, in particular in association with the dependent claims and the figures.

The excitation light is electromagnetic radiation, in particular in the visible spectral range and adjoining ranges. The only demand placed on the contrast-providing principle by the present invention is that the sample emits emission light as a consequence of the irradiation by the excitation light. Typically, the emission light is fluorescence light which the sample, in particular dye molecules present there, emits or emit as a consequence of the irradiation by the excitation light.

The term “illumination beam path” denotes all optical beam-guiding and beam-modifying components, for example lenses, mirrors, prisms, gratings, filters, stops, beam splitters, by means of which and via which the excitation light is guided from a light source, for example a laser, as far as the sample to be examined. The illumination beam path includes at least the illumination control device, for example a scanner with at least one galvanometric mirror, and an illumination objective. The illumination objective may be a microscope objective of a type known per se. The illumination beam path can be realized by the illumination beam path of a laser scanning microscope.

Light emitted by the sample to be examined as a consequence of the irradiation by the excitation light is referred to as emission light and reaches the camera via the detection beam path. The term “detection beam path” denotes all beam-guiding and beam-modifying optical components, for example lenses, mirrors, prisms, gratings, filters, stops, beam splitters, by means of which and via which the emission light is guided from the sample to be examined as far as the camera. The camera is a sufficiently fast optical detector having a two-dimensionally spatially resolving sensor area whose pixels can be rapidly read at least regionally, in particular line by line.

The term “control unit” denotes all hardware and software components which interact with the components of the microscope according to the invention for the intended functionality of the latter. In particular, the control unit can have a computing device, for example a PC, and a camera controller capable of rapidly reading out measurement signals, in particular from lines of the sensor area. According to the invention, the control unit is configured to synchronize in each case regions to be read of a sensor area of the camera, in particular lines of the sensor area, with a position of the excitation light on or in the sample, which position is defined by the illumination control device, for example the scanner, to put it more precisely by the setting of the scanner. The control unit can also be configured for evaluating the image data supplied by the camera.

The term “image splitter unit” denotes all beam-guiding and beam-modifying optical components, for example lenses, mirrors, prisms, gratings, filters, stops, beam splitters, by means of which and via which the emission light is guided into the at least two partial images onto the sensor area of the camera.

The camera can be for example a CMOS or sCMOS camera with rolling shutter electronics. The rolling shutter is expediently synchronized with the scanning speed of the line illumination. The camera pixels read are thus optically conjugate to an instantaneous position of the line focus on the sample. It is likewise possible to use a SPAD camera whose readout matrix is dynamically adjustable, thereby enabling synchronization with the advance of the line focus. By way of example, a camera of the type “pco.edge 10 bi CLHS” from Excelitas PCO GmbH, 93309 Kelheim, Germany can be used.

For fluorescence microscopy with a plurality of dyes, it can also be preferred for the camera to be a color resolution camera. By way of example, the camera can have a Bayer filter.

Higher degrees of parallelization of the image recording and thus higher frame and volume rates are possible if the camera is configured for rapid continuous readout of more than one region, in particular more than one line. By way of example, the camera can have a plurality of rolling shutter stops. For the purposes of the invention, such a camera can also be used by way of methods according to the invention being adapted to the prevailing situation both in terms of illumination and in terms of detection. Specifically, a corresponding illumination of the sample is then provided for each available region to be read. By way of example, with the use of the camera having a plurality of rolling shutter stops, the sample can be simultaneously illuminated with a plurality of illumination lines which are guided over the sample by the illumination control device, in particular a scanner.

For receiving or holding the sample, the microscope can have a sample mount of a type known per se.

The illumination objective and the microscope objective can be separate objectives, for instance in the case of transmitted-light illumination. However, it is also possible for the illumination objective and the microscope objective to be one and the same objective. For separating the emission light from portions of the excitation light in the light reflected back overall from the sample, a main color splitter can then expediently be present. Optionally, a plurality of microscope objectives, exchangeable in particular manually or by the controller, can be present, in a manner arranged for example on a turret or a linear slide.

At least one light source, in particular a laser, can be present for providing the excitation light. The spectral composition of the excitation light can be adjustable, in particular between two or more colors. The excitation light can also simultaneously be polychromatic, for example if different dyes are intended to be detected simultaneously. For these or other applications, the main color splitter can be a double bandpass filter or multiple bandpass filter.

In a manner known per se, the illumination beam path can include a lens system for the imaging of the scanner or the scanners in a back focal plane of the illumination objective.

What can be considered to be one essential concept of the present invention is, firstly, that the emission of light emitted by the sample and containing the microscopic information to be extracted is split into a plurality of partial beams which then each generate partial images of the sample in the plane of the sensor area. A further essential concept of the present invention is that the partial images are positioned on the sensor area of the camera such that the rapid readout, in particular of the pixels of a line, can be used simultaneously for all the partial images.

By way of example, the image splitter unit can place three partial images of the sample from different depths onto the sensor area of a camera next to one another such that for all the partial images the position of the line focus is incident on the same sensor lines. In the case where the direction of propagation of the line is parallel to or coincides with the optical axis of the microscope objective, images corresponding e.g. to three planes of the sample which laterally cover the same region are placed on the camera. In the case of an inclination of the direction of propagation of the line illumination, the images would be offset laterally relative to one another. What is crucial is that the adjustable electronic detection stop of the camera substantially coincides with the region illuminated by the line in the respective plane.

The present invention provides a microscope and a method for microscopy in which the energy input into the sample, in particular on the basis of axial multiple scanning, is used more effectively for imaging purposes. The effective irradiation duration of the sample is thereby shortened and higher frame and volume rates can be achieved for the same total radiation load. The technical equipment complexity is kept reasonable in this case. In particular, existing microscopes can be retrofitted with the components necessary for realizing the invention. Optionally, the detection optical unit can be adapted to a specific sample to be examined and to a specific measurement task.

In the case of the microscope according to the invention and the method according to the invention, the linear regions in the partial images which lie next to one another on the sensor area can be in particular optically conjugate to the linearly illuminated regions on or in the sample.

In this context, optically conjugate means in particular that between the optically conjugate areas or area regions there is a point-to-point relationship mediated by the optical unit. In the specific example, therefore, between the points on or in the linearly illuminated regions on or in the sample there is a point-to-point relationship with points in the linear regions of the partial images. The term point-to-point relationship mediated by the optical unit between a point in the object space (of the sample) and a point on the sensor area of the camera means that a beam emanating from the point in the object space is imaged into the point on the sensor area of the camera by the optical unit.

In principle, the invention is realized in arrangements in which a distance between the illumination objective and the sample is manually altered and adjusted. In one advantageous configuration of the microscope according to the invention, a controllable displacement device for changing a distance between the illumination objective and the sample is present, and the control unit is configured for controlling the displacement device, in particular in a manner coordinated with the control of the illumination control device. With this apparatus supplementation, volume scans can be carried out in an automated manner.

Preferably, the sample is illuminated and scanned with a linear distribution of the excitation light. Advantageously, for this purpose, a cylindrical optical unit, or an anamorphic optical unit, for example a cylindrical lens, said cylindrical optical unit being in particular pivotable into the illumination beam path, is present in the illumination beam path for the purpose of generating the linear distribution of the excitation light in a sample plane. Alternatively or supplementarily, a Powell lens, in particular pivotable into the illumination beam path, can be present in the illumination beam path for the purpose of generating the linear distribution of the excitation light in a sample plane.

In principle, for many applications it can be sufficient if the linear distribution of the excitation light has an invariable width. In one advantageous further development of the microscope according to the invention, a second cylindrical optical unit, for example an astigmatic lens, said second cylindrical optical unit being in particular pivotable into the illumination beam path, is present in the illumination beam path for the purpose of varying a width of a line focus in the sample plane.

In principle, for many applications it can be sufficient if the axial distribution of the excitation light, i.e. the intensity distribution of the excitation light in the direction of the optical axis, has an invariable width. Particularly with regard to volume scans, however, it can be advantageous if the illumination beam path includes optical means, in particular lenses and/or stops, for adjusting a numerical aperture and thus a focus depth or depth of focus of the linear illumination. By way of example, a zoom optical unit can be present for adjusting the focus depth of the linear illumination in the illumination beam path. Alternatively or supplementarily, a stopping-down device can be present for adjusting the focus depth of the linear illumination in the illumination beam path.

The illumination control device serves for spatially manipulating or positioning the excitation light on or in the sample. The illumination control device can have for example a, in particular galvanometric, scanner of a type known per se. Alternatively or supplementarily, the illumination control device can have a, in particular controllable and/or programmable, micromirror array, DMD.

If the extent of the linear distribution of the excitation light in the direction of the line is greater than the extent of the observed image field of the partial images, one scanner is sufficient, which moves the linear distribution of the excitation light over or through the sample in a direction transversely with respect to the direction of the line. In a further advantageous supplementation of the microscope according to the invention, the illumination control device has a second scanner for scanning in a direction parallel to the line illumination. This scanner can serve in particular to scan the sample in the extension direction of the illumination line and/or to adapt a length of the illumination line in the sample to a desired value.

Alternatively or supplementarily, in this context, in the illumination beam path, too, an excitation filter, for example in a filter cube, can be replaced by a cylindrical lens, which is then scanned through. This technical solution can be straightforwardly retrofitted to any laser scanning microscope.

The invention is realized in principle when the image splitter unit is arranged somewhere between the sample and the camera.

The image splitter unit can have components known per se for splitting the emission light. In one configuration, the image splitter unit has at least one diffractive device, in particular a grating and/or a spatial light modulator, for splitting the emission light. The diffractive device is preferably arranged in a pupil or in the vicinity of a pupil of the detection beam path.

A pupil plane is taken to mean the back focal plane of the microscope objective, i.e. the focal plane situated on the other side from the sample, or a plane optically conjugate to the back focal plane of the microscope objective.

In other variants of the microscope according to the invention, the image splitter unit for splitting the emission light alternatively or supplementarily has at least one monolithic component, consisting for example of adhesively bonded and/or coated prisms or plates. Such components can be non-adjustable, in particular.

In advantageous variants of the microscope according to the invention which allow in particular relatively uncomplicated retrofittability to existing microscope systems, the image splitter unit is arranged in the detection beam path between an intermediate image downstream of a tube lens and the camera.

The image splitter unit can be realized for example such that the emission light is split by beam splitters and is then guided by respectively separate optical means into diffraction-limited partial images onto the camera. In one advantageous configuration of the microscope according to the invention, the image splitter unit has a relay lens system comprising an entrance lens and an exit lens, between which at least one beam splitter is arranged. In this variant, at least the exit lens of the relay lens system can be used simultaneously by at least two partial beam paths.

In order to be able to laterally measure point spread functions, for example if individual dye molecules are intended to be localized, a magnification of the relay lens system of the image splitter unit can advantageously be chosen such that the diameter of an Airy disk on the sensor area of the camera is at least four times the magnitude of a distance between adjacent pixels of the camera. In this case, the diameter of the Airy disk is understood to mean the diameter of the first diffraction minimum, i.e. of the first dark ring.

Equivalent to this is the requirement that the magnification of the relay lens system of the image splitter unit is chosen such that the full width at half maximum of the point spread function belonging to the Airy disk on the sensor area of the camera is at least double the magnitude of a distance between adjacent pixels of the camera. The full width at half maximum of the point spread function is understood here to mean the diameter of the region at whose boundary the intensity of the point spread function has fallen to half the maximum.

A particular advantage of the invention is that there is freedom of design concerning the parameter(s) in which the partial images differ. By way of example, the partial images can belong to planes spaced apart axially from one another in the sample. For this purpose, at least one of the beam splitters, in particular more than one or each of the beam splitters, can be a neutral splitter, i.e. the partial beam paths can be identical from a spectral standpoint. In another variant, the partial images differ from one another from a spectral standpoint. By way of example, a first dye can essentially be visible in a first partial image and a second dye can essentially be visible in a second partial image.

For this purpose, at least one of the beam splitters, in particular more than one or each of the beam splitters, can be a dichroic beam splitter, i.e. the partial beam paths can be different from a spectral standpoint. The use of two-colored or multicolored excitation light can be advantageous in this case.

Mixed forms of these variants are possible, in principle, that is to say that the partial images can both belong to axially spaced apart sample planes and be spectrally different. That can be advantageous in special situations.

In a manner known per se, at least one of the beam splitters and in particular more than one or each of the beam splitters can be arranged so as to be exchangeable and/or switchable, for example on a linear slide or a turret.

Preferably, the partial beam paths are fed to the exit lens of the relay lens system such that the associated at least two partial images are arranged next to one another on the sensor area of the camera in such a way that linear regions in the partial images which in particular are optically conjugate to linearly illuminated regions on or in the sample lie on the same line or the same lines of the sensor area.

A further advantageous configuration of the microscope according to the invention is distinguished by the fact that, in particular controllable, deflection elements, in particular deflection mirrors, are present in at least one of the partial beam paths of the image splitter unit, preferably in a plurality or all of the partial beam paths of the image splitter unit. Preferably, the control unit can then additionally be configured to control the controllable deflection elements using a control signal for the camera in such a way as to satisfy a confocal condition for all images of the respective planes by way of the confocal readout region.

In connection with the beam splitters to be used, it has already been explained that, in one variant of the invention, the at least two partial images can belong to axially offset regions of the sample. By way of example, in a further variant of the microscope according to the invention, an additional lens can be arranged in at least one of the partial beam paths of the image splitter unit, preferably in a plurality or all of the partial beam paths of the image splitter unit. Different axial poses of the sample planes belonging to the partial images can be attained by means of said lens or lenses.

What is particularly advantageous, moreover, is one development of the microscope according to the invention where an axial distance between the sample planes to which the partial images belong and which are optically conjugate to the plane of the sensor area is adjustable. By way of example, a focal length of the at least one additional lens can be adjustable in a variable manner and in particular to infinity. The at least one additional lens can be an electrically adjustable lens (ETL). The control unit can be configured to control the focal length of the at least one additional lens.

Alternatively, glass blocks of different thicknesses can also be introduced in a region between the output lens and the sensor area of the camera in a plane in which the partial images no longer overlap, in order to produce the respectively desired axial offset of the partial images with respect to one another.

In one advantageous supplementation, in the case of the microscope according to the invention, deflection elements and/or glass blocks can be present for the purpose of adjusting axial poses of the pupils for the partial beam paths in the image splitter unit.

In a further preferred configuration of the microscope according to the invention, a field stop is present for the purpose of adapting a size of the partial images in an intermediate image plane in the detection beam path. Suitable adjustment of said field stop makes it possible to prevent the partial images from overlapping on the sensor area of the camera.

In one important variant of the method according to the invention, images of extensive volume regions are recorded, i.e. volume scans are carried out. In comparison with the prior art, that is possible more quickly and with a reduced light burden on the sample, i.e. with comparatively gentle treatment of the sample, by means of the present invention.

In a manner known per se, regions of interest can be selected from the images of an extensive volume region, in particular in an automated manner, and are then examined more closely using a laser scanning microscope.

Furthermore, in a manner known per se, on the basis of measurement data of a laser scanning microscope pertaining to a sample, a decision can be taken, in particular in an automated manner, regarding the volume regions of the relevant sample which will be chosen for recording images thereof.

In the case of the volume scans, the sample planes belonging to the partial images are axially offset relative to one another and the distance between the microscope objective and the sample is altered over a specific scanning travel with a step size to be defined and a number of images corresponding to the number of partial images are recorded for each distance between the sample and the microscope objective. The individual images can then be combined by the control unit to form a 3D image of the observed volume.

In principle, a focus depth or depth of focus of the linear illumination can be invariable. Preferably, the focus depth of the linear illumination is adjusted to a value corresponding to an axial distance between two sample planes—in particular, if more than two sample planes are imaged simultaneously, the distance between the two axially outer sample planes—which are optically conjugate to the plane of the sensor area of the camera. This is expedient in particular for volume scans where an optimum ratio between image quality and light burden on the sample is desired.

Besides simple Gaussian illumination profiles, more complex beam shapings can also be used. For example, a plurality of foci can be generated using diffractive optical elements.

In order to axially sample a point spread function, the axial distance between the observed sample planes should not be greater than half the axial depth of focus of the imaging of the microscope objective in the detection beam path. That is also referred to as axial Nyquist sampling. If it is assumed that, in the case of volume scans, the axial distance between the sample planes is greater than the axial step size, this gives rise to the requirement that the axial step size, in particular of the adjustment of the distance between the sample and the microscope, is chosen to be less than half the axial depth of focus of the imaging of the microscope objective in the detection beam path. In principle, however, it is also possible for the axial distance between the sample planes belonging to the partial images to be less than or equal to the depth of focus of the imaging of the microscope objective in the detection beam path. The axial step size can then be correspondingly larger. An application of the invention that does not satisfy the axial Nyquist condition, i.e. undersampling, is moreover also possible, of course. This may be desirable for example if fast volume scans are intended to be carried out.

In one preferred variant of the method according to the invention, in the case of volume scans an axial distance between the sample planes belonging to the partial images is an integral multiple of the axial step size. Apart from the planes at the axial limits of the scanned volume, a plurality of images of the sample planes are then recorded in each case, specifically according to the number of partial images defined by the image splitter unit. This choice of the step size also allows the correct linking of the respectively following image stack to be checked in each case.

In another variant of the method according to the invention, in the case of volume scans an axial step size is an integral multiple of the axial distance between the sample planes belonging to the partial images. By way of example, the axial step size can be n times the axial distance between the sample planes belonging to the partial images, where n is the number of sample planes and partial images. Rapid volume scans are possible with this choice of the axial step size.

Mixed forms of these variants are possible. It is advantageous that the axial distances between the sample planes and the axial step size in the case of volume scans can be chosen freely over wide ranges.

Further increases in the frame and volume rates are possible if the sample is scanned with a plurality of linear illumination regions and the regions of the sensor area of the camera which correspond to the linear illumination regions are read in a synchronized manner in each case.

In general, the excitation light is radiated onto the sample parallel to the optical axis of the illumination objective. For specific samples, however, it can also be preferred for a linear laser illumination to be radiated into the sample at an angle with respect to the optical axis of the illumination objective. The sample regions corresponding to the partial images are then displaced laterally relative to one another. The sampled volumes can then substantially correspond to a parallelepiped.

Further advantages and properties of the present invention are explained in association with the accompanying figures, in which:

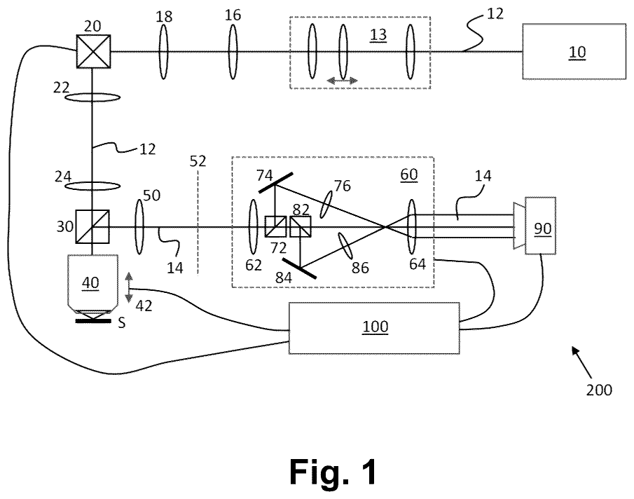

FIG. 1: shows a schematic illustration of one exemplary embodiment of a microscope according to the invention;

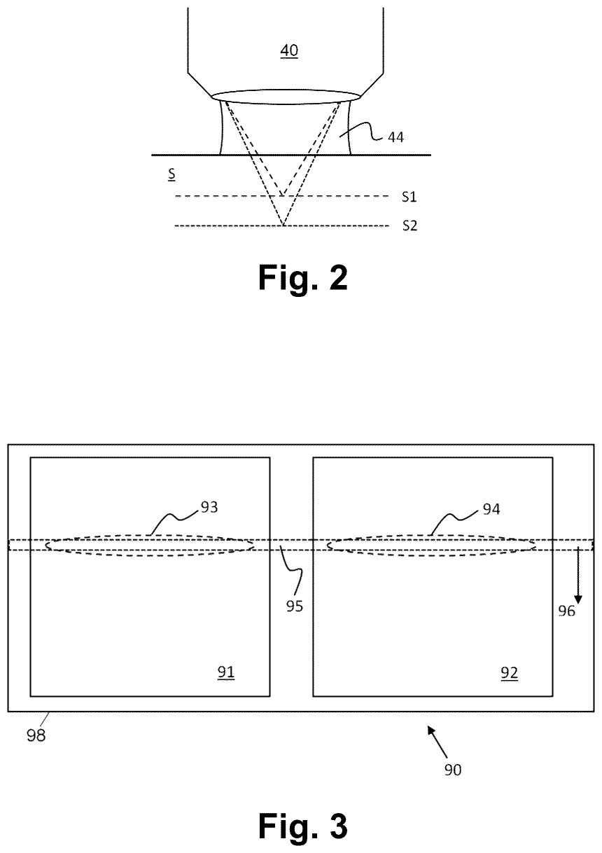

FIG. 2: shows a schematic illustration of a diagram of the illumination situation in a sample; and

FIG. 3: shows a schematic illustration of the sensor area of the camera with two partial images, corresponding to respective different z-depths within the sample.

Identical and identically acting components are generally identified by the same reference signs in the figures. One exemplary embodiment of a microscope 200 according to the invention will be explained with reference to FIGS. 1 to 3.

The microscope 200 according to the invention, illustrated schematically in FIG. 1, has as essential components an illumination beam path, a detection beam path and a control unit 100, for example a PC.

The illumination beam path serves for illuminating and scanning a sample S with excitation light 12 and, in the example shown, besides other components, includes a scanner 20 as illumination control device and an illumination objective 40. Owing to the irradiation with the excitation light 12, the sample S emits emission light 14, which is imaged onto a sensor area 98 of a camera 90 via the detection beam path. Besides other components, the detection beam path includes the microscope objective 40, which is identical with the illumination objective 40 in the example shown, and, as an essential constituent part of the microscope according to the invention, the image splitter unit 60. The image splitter unit 60 serves to split the emission light 14 coming from the sample S and to image it onto a sensor area 98 of the camera in a qualified manner. The camera 90 serves for recording images of the sample S. The control unit 100 serves for controlling at least the scanner 20 and the camera 90.

The illumination beam path can be realized by the illumination beam path of a laser scanning microscope.

The excitation light 12 is fed into the illumination beam path by a laser 10 and is scanned over the sample S by the scanner 20 through the microscope objective 40. The imaging of the scanner 20, for example of the scanning mirror or scanning mirrors, into a back focal plane of the illumination objective 40 (pupil plane) is effected via a lens system comprising scanning optical unit 22 and tube lens 24. A cylindrical optical unit, in particular a cylindrical lens 18, generates preferably a linear distribution of the excitation light 12 in the pupil plane and a sample plane. Owing to the Fourier relation between pupil plane and image plane, these planes are perpendicular to one another.

Supplementarily or alternatively, for the purpose of generating a linear distribution of the excitation light 12, a cylindrical lens can be present on the illumination-side entrance side of the main beam splitter 30, which will be described below.

In the exemplary embodiment shown, a second cylindrical optical unit, which is capable of being switched on or is exchangeable, for example is capable of being pivoted in, for example a cylindrical lens 16, is additionally present for the purpose of adjusting a width of the line focus.

In the exemplary embodiment shown, a zoom optical unit 13 is additionally present in the illumination beam path, and enables a focus depth or depth of focus of the line illumination in the sample S to be adjusted. Supplementarily or alternatively, a stopping-down device (not illustrated in FIG. 1) can be present in the illumination beam path for the purpose of adjusting the focus depth of the illumination.

The line focus is moved by the scanner 20 in a direction transversely with respect to the extension direction of the line focus in the sample S. Optionally, for the purpose of scanning the excitation light 12 in a direction parallel to the line illumination, a second scanner can be present as part of the illumination control device.

In the exemplary embodiment shown, a distance between the microscope objective 40 and the sample S can be adjusted by a displacement device 42, for example a motorized z-drive.

The emission light 14, in particular fluorescence light, generated in the sample S on account of the irradiation with the excitation light 12 is collimated by the microscope objective 40 and is deflected by the main color splitter 30, a dichroic beam splitter, in the detection beam path in the direction of the camera 90. Consequently, the emission light 14, i.e. the fluorescence light, does not pass via the scanner 20.

An intermediate image plane 52 downstream of a tube lens 50 is followed by the image splitter unit 60, which, in the exemplary embodiment shown, generates three partial images from different depth regions of the sample S and arranges them next to one another on the sensor area 98 of the camera 90, for example a CMOS chip or a SPAD array. The camera 90 can also be a color resolution camera.

The camera 90, the scanner 20 and the displacement device 42 are operatively connected to one another via the control unit 100.

The control unit 100 is configured in particular to synchronize the position—defined by a setting of the scanner 20—of the line illumination in the sample S with the respective regions to be read of the sensor area 98 of the camera 90, for instance in the manner of a rolling shutter. The control unit 100 can also be configured for controlling the displacement device 42, in particular in a manner coordinated with the control of the scanner 20.

In the exemplary embodiment shown in FIG. 1, the image splitter unit 60 is arranged in the detection beam path between an intermediate image 52 downstream of a tube lens 50 and the camera 90.

The image splitter unit 60 has an optical relay lens system comprising an entrance lens 62 and an exit lens 64, which images the intermediate image plane 52 onto the sensor area 98 of the camera 90. A magnification of the relay lens system can be chosen here such that a desired number of partial images, i.e. three partial images in the exemplary embodiment in FIG. 1, are imaged onto the sensor area 98 such that point spread functions can be laterally sampled. This means that the magnification of the relay lens system 62, 64 of the image splitter unit 60 is chosen for example such that the diameter of an Airy disk on the sensor area 98 of the camera 90 is at least four times the magnitude of a distance between adjacent pixels of the camera 90. Optionally, a field stop can be present in the intermediate image plane 52 in order to avoid an overlap of the partial images on the sensor area of the camera 98.

In the exemplary embodiment shown, beam splitters 72, 82 are present between the entrance lens 62 and the exit lens 64 of the relay lens system, and split the emission light 14 into a first, a second and a third partial beam path.

In the first partial beam path, the emission light 14 passes from the beam splitter 72 via an adjustable mirror 74 and a lens 76 to the exit lens 64 and is imaged by the latter into a first partial image 91 onto the sensor area 98 of the camera 90.

In the second partial beam path, the emission light 14 passes from the beam splitter 82 via an adjustable mirror 84 and a lens 86 to the exit lens 64 and is imaged by the latter into a second partial image 92 onto the sensor area 98 of the camera 90.

In the third partial beam path, the emission light 14 passes through both beam splitters 72, 82, and passes directly to the exit lens 64 and from the latter onto a third partial image on the sensor area 98 of the camera 90.

In the exemplary embodiment shown, the neutral splitter 82 could also be a simple mirror. The third partial beam path and accordingly the third partial image would then be omitted.

The control unit 100 can be configured to control the adjustable mirrors 74, 84 using a control signal for the camera 90 in such a way as to satisfy a confocal condition for all the partial images of the respective planes by way of the confocal readout region.

The first partial beam path and the second partial beam path are fed to the exit lens 64 of the relay lens system 62, 64 such that the associated at least two partial images 91, 92 are arranged next to one another on the sensor area 98 of the camera 90 in such a way that linear regions 93, 94 in the partial images 91, 92 which are optically conjugate to linearly illuminated regions on or in the sample S lie on the same line or the same lines 95 of the sensor area 98 (FIG. 3).

In addition, deflection elements or glass blocks (not shown in FIG. 1) can be present in the first and/or second partial beam path in order to adjust the pupil poses for the partial images.

The lens 76 in the first partial beam path defines the axial pose of a plane S1 in the sample S which is optically conjugate to the plane of the sensor area 98. The lens 86 in the second partial beam path defines the axial pose of a plane S2 in the sample S which is optically conjugate to the plane of the sensor area 98. Accordingly, the axial poses of the sample planes S1 and S2 which are optically conjugate to the plane of the sensor area 98 can be adjusted by means of a suitable choice of the lenses 76 and 86. Preferably, in particular for volume scans, a certain axial distance is adjusted for the sample planes S1 and S2. Expediently, with the zoom optical unit 13, a focus depth of the illumination with the excitation light 12 can then additionally be adjusted such that the two sample planes are irradiated sufficiently, but adjacent regions are irradiated as little as possible, with the excitation light 12. The adjustment of the focus depth is intended to have the effect that the adjacent regions have a low illumination density, i.e. a larger area is illuminated. This would be achieved if the simultaneously observed sample planes the furthest away from one another were still just within the focus depth of the illumination, as described in the next paragraph.

Preferably, the focus depth of the linear illumination is adjusted to a value corresponding to an axial distance between two sample planes S1, S2 which are optically conjugate to the plane of the sensor area 98 of the camera 90.

Advantageously, the focal length of the lenses 76, 86 is adjustable by virtue of the lenses either being exchangeable or being embodied for example as electrically adjustable lenses (so-called electrically tunable lens, ETL), the focal length of which is then also adjustable by the control unit 100. The distance between the sample planes S1, S2 conjugate to the camera image plane and a focal plane of the microscope objective 40 can be adjusted in this way.

The adjustable lenses 76, 86 are preferably also adjustable in particular such that the sample planes S1 and S2 are not spaced apart axially. By way of example, for both lenses 76, 78 the focal length can be set to infinity. With the arrangement shown in FIG. 1, the first partial image 91 and the second partial image 92 would then be ideally identical.

Expediently, the beam splitters 72 and 82 can then be replaced by different dichroic beam splitters coordinated with the observation of chromatically different dyes. By way of example, a first dye can be represented in centroid terms in the first partial image 91 and a second dye can be represented in centroid terms in the second partial image 92. The sample S is thus observed simultaneously in two color channels, in which case the line illumination is still guided over the sample S in a synchronized manner with the rolling shutter of the camera 90.

The sample S can be for example a cell conglomerate having a thickness of about 15 μm. The microscope objective 40 can be for example an objective 40×/1.2. The depth of focus of the imaging is then approximately 0.5 μm, such that axial Nyquist sampling with a step size of 0.25 μm is achieved. Instead of two partial images, as shown in the figures, for example three partial images can also be recorded simultaneously. The axial distance between the three sample planes can be adjusted to 2.5 μm, for example, that is to say that the outer sample planes are axially spaced apart by 5 μm. An axial travel of 5 μm can then be traversed uniformly in steps of 0.25 μm steps, without the need for jumps of different magnitudes with possibly different time delays. The number of images to be recorded would be reduced by a factor of three to only 20 images. Given an image repetition rate of the camera of 120 fps (frames per second), six volumes per second would accordingly be recorded. What is advantageous in this case is that there is a coverage of the respective first and last planes in the regions which lie within the sample (see FIG. 2). A correct linking of the image recordings can be ensured as a result.

A controlled placement of the partial images 91, 92 on the camera 90 is furthermore preferred. In this case, proceeding from the signal on the sensor area 98 of the camera 90, in the control unit 100 according to defined criteria it is possible to realize control of the deflection mirrors 74, 84, which are adjustable in particular in a motorized manner, which control ensures that the placed partial images 91, 92 do not overlap and, moreover, lie next to one another such that the region of confocal readout optimally overlaps the illumination region.

FIG. 2 shows a schematic illustration of the microscope objective 40 relative to the sample S. An immersion medium for matching the refractive indices is situated between the microscope objective 40 and the sample S. Two Sample planes S1 and S2 are then illustrated. The first sample plane S1 is optically conjugate to the first partial image 91 (FIG. 3) via the first partial beam path, running via the components 62, 72, 74, 76, 64. The second sample plane S2 is optically conjugate to the second partial image 92 (FIG. 1, FIG. 3) via the second partial beam path, running via the components 62, 82, 84, 86, 64. An extent of the axial distribution of the excitation light 12 approximately corresponds to the axial distance between the sample planes S1 and S2.

FIG. 3 shows a schematic illustration of the sensor area 98 of the camera 90. As can be seen, the first partial image belonging to the first partial beam path, said first partial image being an image of the sample plane S1, lies next to the second partial image 92 belonging to the second partial beam path, said second partial image being an image of the sample plane S2. A linear region 93 in the first partial image 91 corresponds to a region that is optically conjugate to the pose of the line illumination in the first sample plane S1. A linear region 94 in the second partial image 92 corresponds to a region that is optically conjugate to the pose of the line illumination in the second sample plane S2. As can be seen, the first partial image 91 and the second partial image 92 lie next to one another on the sensor area 98 in such a way that the linear regions 93, 94 in the partial images 91, 92 which are optically conjugate to linearly illuminated regions on or in the sample S lie on the same line or the same lines 95 of the sensor area 98. The control unit 100 is configured to read out and evaluate the measurement signals measured from the pixels lying in the line or the lines 95. With the movement of the line focus in the sample S with the aid of the scanner 20 transversely with respect to the extension direction of the line focus, the region respectively to be read of the sensor area 98 of the camera 90 is also concomitantly guided in the direction of the arrow 96.

### LIST OF REFERENCE SIGNS

10 Light source, in particular laser
12 Excitation light
13 Zoom optical unit for adjusting the focus depth of the illumination
14 Emission light
16 Cylindrical lens, in particular capable of being pivoted in
18 Cylindrical lens, in particular capable of being pivoted in
20 Illumination control device, e.g. galvo scanner
22 Scanning optical unit
24 Tube lens in the illumination beam path
30 Main color splitter
40 Illumination objective, microscope objective
42 Controllable displacement device
44 Immersion liquid (optional, depending on the objective 40)
50 Tube lens in the detection beam path
52 Intermediate image plane
60 Image splitter unit
62 Entrance lens
64 Exit lens
72 Beam splitter, in particular neutral splitter
74 Deflection device, in particular mirror, in particular controllable
76 Lens, in particular with adjustable focal length
82 Beam splitter, in particular neutral splitter
84 Deflection device, in particular mirror, in particular controllable
86 Lens, in particular with adjustable focal length
90 Camera
91 First partial image
92 Second partial image
93 Linear region, corresponding to and optically conjugate to linear illuminated region on or in sample S
94 Linear region, corresponding to and optically conjugate to linear illuminated region on or in the sample S
95 One or more lines to be read of the sensor area 98
96 Direction of movement of the line or lines to be read
98 Sensor area of the camera 90
100 Control device, in particular PC
200 Microscope according to the invention
S Sample
S1 First sample plane
S2 Second sample plane

1. A microscope comprising:
an illumination beam path at least including an illumination control device and an illumination objective for illuminating and scanning a sample with excitation light,
a detection beam path at least including a microscope objective for guiding emission light emitted by the sample in the direction of a camera,
the camera for recording images of the sample, and
a control unit for controlling at least the illumination control device and the camera,
the control unit being configured to synchronize in each case regions to be read of a sensor area of the camera with a position of the excitation light defined by the illumination control device,
wherein
the detection beam path includes an image splitter unit for splitting the emission light into a plurality of partial beam paths which each generate a partial image of the sample on the sensor area of the camera, the partial images lying next to one another on the sensor area in such a way that linear regions in the partial images which correspond to a position of the excitation light on or in the sample as defined by the illumination control device lie on the same line or the same lines of the sensor area.

2. The microscope as claimed in claim 1,
wherein
the linear regions in the partial images which lie next to one another on the sensor area are optically conjugate to linearly illuminated regions on or in the sample.

3. The microscope as claimed in claim 1,
further comprising a controllable displacement device for changing a distance between the illumination objective and the sample, and
wherein the control unit is configured for controlling the displacement device.

4. The microscope as claimed in claim 1,
further comprising a cylindrical optical unit in the illumination beam path for generating a linear distribution of the excitation light in a sample plane.

5. The microscope as claimed in claim 1,
further comprising a second cylindrical optical unit in the illumination beam path for varying a width of a line focus in the sample plane.

6. The microscope as claimed in claim 1,
further comprising lenses and/or stops for adjusting a focus depth of the linear illumination in the illumination beam path.

7. The microscope as claimed in claim 1,
wherein
the illumination control device has at least one scanner and/or at least one micromirror array.

8. The microscope as claimed in claim 1,
wherein
the image splitter unit for splitting the emission light has at least one diffractive device.

9. The microscope as claimed in claim 1,
wherein
the image splitter unit for splitting the emission light has at least one monolithic component.

10. The microscope as claimed in claim 1,
wherein
the illumination control device has a second scanner for scanning the excitation light in a direction parallel to the line illumination.

11. The microscope as claimed in claim 1,
wherein
the image splitter unit is arranged in the detection beam path between an intermediate image downstream of a tube lens and the camera.

12. The microscope as claimed in claim 1,
wherein
the image splitter unit has a relay lens system comprising an entrance lens and an exit lens, between which at least one beam splitter is arranged.

13. The microscope as claimed in claim 12,
wherein
a magnification of the relay lens system of the image splitter unit is chosen such that the diameter of an Airy disk on the sensor area of the camera is at least four times the magnitude of a distance between adjacent pixels of the camera.

14. The microscope as claimed in claim 12,
wherein at least one of the beam splitters is a neutral splitter or a dichroic beam splitter.

15. The microscope as claimed in claim 12,
wherein
the partial beam paths are fed to the exit lens of the relay lens system such that the associated at least two partial images are arranged next to one another on the sensor area of the camera in such a way that linear regions in the partial images lie on the same line or the same lines of the sensor area.

16. The microscope as claimed in claim 1,
further comprising deflection elements in at least one of the partial beam paths of the image splitter unit.

17. The microscope as claimed in claim 16,
wherein
the control unit is configured to control the controllable deflection elements using a control signal for the camera in such a way as to satisfy a confocal condition for all images of the respective planes by way of the confocal readout region.

18. The microscope as claimed in claim 1,
wherein
the at least two partial images belong to axially offset regions of the sample.

19. The microscope as claimed in claim 1,
wherein
an additional lens is arranged in at least one of the partial beam paths of the image splitter unit.

20. The microscope as claimed in claim 1,
wherein
an axial distance between the sample planes to which the partial images belong and which are optically conjugate to the plane of the sensor area is adjustable.

21. The microscope as claimed in claim 1,
wherein
a focal length of the at least one additional lens is adjustable in a variable manner.

22. The microscope as claimed in claim 1,
further comprising deflection elements and/or glass blocks for adjusting the axial poses of the pupils for the partial beam paths in the image splitter unit.

23. The microscope as claimed in claim 1,
wherein
the camera is a CMOS camera or sCMOS camera with rolling shutter electronics or a SPAD camera.

24. The microscope as claimed in claim 1,
wherein
the camera is a color resolution camera.

25. The microscope as claimed in claim 1,
wherein
the camera is configured for rapid continuous readout of more than one region.

26. The microscope as claimed in claim 1,
wherein
the sample regions corresponding to the partial images are displaced laterally relative to one another.

27. The microscope as claimed in claim 1,
further comprising a field stop for adapting a size of the partial images in an intermediate image plane in the detection beam path.

28. A method for microscopy,
wherein a sample is illuminated and scanned with excitation light by an illumination objective,
wherein emission light emitted by the sample is guided in the direction of a camera via a microscope objective,
wherein the emission light downstream of the microscope objective is split into a plurality of partial beam paths,
wherein each of the partial beam paths generates a partial image of the sample on a sensor area of the camera,
wherein the partial images of the sample lie next to one another on the sensor area in such a way that linear regions in the partial images which correspond to a position of the excitation light on or in the sample lie on the same line or the same lines of the sensor area, and
wherein regions to be read of the sensor area of the camera are synchronized with the position of the excitation light on the sample.

29. The method as claimed in claim 28,
wherein
a focus depth of the linear illumination is adjusted to a value corresponding to an axial distance between two sample planes which are optically conjugate to the plane of the sensor area of the camera.

30. The method as claimed in claim 28,
wherein
in the case of volume scans an axial step size is less than or equal to half the axial depth of focus of the imaging of the microscope objective.

31. The method as claimed in claim 28,
wherein
in the case of volume scans an axial distance between the sample planes belonging to the partial images is an integral multiple of the axial step size.

32. The method as claimed in claim 28,
wherein
in the case of volume scans an axial step size is an integral multiple of the axial distance between the sample planes belonging to the partial images.

33. The method as claimed in claim 28,
wherein
the sample is scanned with a plurality of linear illumination regions, and
wherein the regions of the sensor area of the camera that correspond to the linear illumination regions are read in each case in a synchronized manner.

34. The method as claimed in claim 28,
wherein
a linear laser illumination is radiated into the sample at an angle with respect to the optical axis of the illumination objective.
